(19) United States
(12) Patent Application Publication
(10) Pub. No.: US 2005/0102659 A1
(43) Pub. Date: May 12, 2005

(54) Methods and apparatus for setting up hardware loops in a deeply pipelined processor

(76) Inventors: Ravi Pratap Singh, Austin, TX (US); Thang M. Tran, Austin, TX (US); Srikanth Kannan, Burlington, MA (US); Deepa Duraiswamy, Austin, TX (US)

Correspondence Address: William R. McClellan;Wolf, Greenfield & Sacks, P.C., 600 Atlantic Avenue, Boston, MA, 02210, US

(21) Appl. No.: 10/702,363

(22) Filed: Nov. 6, 2003

(51) Int. Cl. G06F 9/45

(52) U.S. Cl. 717/150; 717/160; 712/23

(57) ABSTRACT

Methods and apparatus are provided for issuing instructions in a processor having a pipeline. A method includes providing a loop buffer for holding program loop instructions and a register file for holding loop control parameters; in response to decoding of a first loop setup instruction, marking a first entry in the register file as a current entry and writing in the first entry loop control parameters represented in the first loop setup instruction; marking the current entry in the register file as an architectural entry in response to the first loop setup instruction being committed; and sending a loop bottom indicator down the pipeline with a loop bottom instruction.

### FIELD OF THE INVENTION

This invention relates to digital processors and, more particularly, to methods and apparatus for setting up hardware loops in a deeply pipelined processor.

### BACKGROUND OF THE INVENTION

A digital signal computer, or digital signal processor (DSP), is a special purpose computer that is designed to optimize performance for digital signal processor applications, such as, for example, fast Fourier transforms, digital filters, image processing, signal processing in wireless systems, and speech recognition. Digital signal processor applications are typically characterized by real-time operation, high interrupt rates and intensive numeric computation. In addition, digital signal processor applications tend to be intensive in memory access operations and to require the input and output of large quantities of data. Digital signal processor architectures are typically optimized for performing such computations efficiently. In addition to digital signal processor applications, DSPs are frequently required to perform microcontroller operations. Microcontroller operations involve the handling of data, but typically do not require extensive computation.

Digital signal processors may utilize a pipelined architecture to achieve high performance. As known in the art, a pipelined architecture includes multiple pipeline stages, each of which performs a specified operation, such as instruction fetch, instruction decode, address generation, arithmetic operations, and the like. Program instructions advance through the pipeline stages on consecutive cycles, and several instructions may be in various stages of completion simultaneously.

Performance can be enhanced by providing a large number of pipeline stages. The number of pipeline stages in a processor is sometimes referred to as pipeline depth. Notwithstanding the enhanced performance provided by pipelined architectures, certain program conditions may degrade performance. An example of such a program condition is a program loop. Program loops are common in most computer programs, including for example digital signal processor applications, where it is frequently necessary to repeat one or more operations multiple times. A program loop may degrade performance because each iteration of the loop involves a branch from the loop bottom to the loop top. If the branch instruction is not handled correctly, it may be necessary to abort all instructions currently in the pipeline following the branch instruction and to re-execute instructions from the branch. Furthermore, where a program loop is executed multiple times, it is inefficient to fetch and decode the same loop instructions multiple times. For deeply pipelined architectures and programs having frequent program loops, the performance penalty may be severe.

Hardware loops have been proposed to alleviate these problems. See, for example, U.S. Patent Application Publication No. 2002/0078333, published Jun. 20, 2002. Hardware loops include a buffer which holds some or all of the instructions of the loop, registers which contain loop parameters, and control circuitry which issues instructions from the loop buffer in accordance with the loop parameters. Instructions are issued from the loop buffer without incurring the normal penalties.

Notwithstanding the advantages of hardware loops, certain program loop conditions may result in inefficient execution, particularly in deeply pipelined processors. Examples of such conditions include very short program loops and program loops that follow other program loops immediately or nearly immediately. These conditions may cause the processor to be stalled temporarily, thereby degrading performance. Accordingly, there is a need for improved methods and apparatus for handling program loops in deeply pipelined processors.

### SUMMARY OF THE INVENTION

According to a first aspect of the invention, a method is provided for issuing instructions in a processor having a pipeline. The method comprises providing a loop buffer for holding program loop instructions and a register file for holding speculative and architectural loop control parameters; in response to decoding of a first loop setup instruction, marking a first entry in the register file as a current entry and writing in the first entry loop control parameters represented in the first loop setup instruction; marking the current entry in the register file as an architectural entry in response to the first loop setup instruction being committed in the pipeline; and sending a loop bottom indicator down the pipeline with a loop bottom instruction.

The register file preferably has at least three entries. Instructions of the program loop may be issued according to the loop control parameters in the current entry in the register file. A loop count in the architectural entry in the register file may be decremented in response to the loop bottom instruction being committed.

The method may further comprise generating a current pointer to the current entry in the register file and generating an architectural pointer to the architectural entry in the register file. The current pointer may be incremented to a second entry in the register file in response to decoding of a second loop setup instruction, and loop control parameters represented in the second loop setup instruction may be written in the second entry. The architectural pointer may be incremented to the second entry in the register file in response to the second loop setup instruction being committed.

The current pointer may be moved to the location of the architectural pointer in response to an interrupt or a pipeline abort. The loop setup instruction may be stalled when the register file does not have an available entry.

The method may further comprise writing a temporary loop count in a temporary loop count register and decrementing the temporary loop count on each loop bottom match. The program loop is complete when the temporary loop count has decremented to zero.

Each entry in the register file comprises a loop top register for holding a loop top address, a loop bottom register for holding a loop bottom address and a loop count register for holding a loop count. A loop top comparator compares a current instruction address with the loop top address to determine a loop top match. A loop bottom comparator compares the current instruction address with the loop bottom address to determine a loop bottom match. Instructions are issued without sending the loop control parameters down the pipeline.

According to a second aspect of the invention, a method is provided for controlling a program loop in a processor having a pipeline. The method comprises providing a loop buffer for holding program loop instructions and a register file having at least three entries for holding speculative and architectural loop control parameters; marking a first entry in the register file as a current entry in response to decoding of a first loop setup instruction and writing in the first entry loop control parameters represented in the first loop setup instruction; and marking the first entry in the register file as an architectural entry in response to the first loop setup instruction being committed in the pipeline.

According to a third aspect of the invention, apparatus is provided for issuing instructions in a processor having a pipeline. The apparatus comprises a loop buffer for holding program loop instructions; a register file having at least three entries for holding speculative and architectural loop control parameters; and a controller including means for marking a first entry in the register file as a current entry in response decoding of a first loop setup instruction and for writing in the first entry loop control parameters represented in the first loop setup instruction, and means for marking the current entry in the register file as an architectural entry in response to the first loop setup instruction being committed.

The controller may further comprise means for issuing instructions of the program loop according to the loop control parameters in the current entry in the register file, sending a loop bottom indicator down the pipeline with a loop bottom instruction, and decrementing a loop count in the architectural entry in the register file in response to the loop bottom instruction being committed in the pipeline.

### BRIEF DESCRIPTION OF THE DRAWINGS

The accompanying drawings, are not intended to be drawn to scale. In the drawings, each identical or nearly identical component that is illustrated in various figures is represented by a like numeral. For purposes of clarity, not every component may be labeled in every drawing. In the drawings:

FIG. 1 is a simplified block diagram of a digital processor having a pipelined architecture;

FIG. 2 is a simplified block diagram of the fetch unit and the decode unit shown in FIG. 1;

FIG. 3 is a simplified block diagram of a hardware loop unit in accordance with an embodiment of the invention;

FIG. 4 is a state machine diagram of a controller of the hardware loop unit in accordance with an embodiment of the invention;

FIG. 5 is a table that illustrates operation of the hardware loop unit in issuing instructions for a long program loop;

FIG. 6 is a flow diagram that illustrates processing of a loop setup instruction in accordance with an embodiment of the invention;

FIG. 7 is a flow diagram that illustrates a process for issuing loop instructions in accordance with an embodiment of the invention;

FIGS. 8A-8D illustrate a register file for storing loop control parameters in different processor states; and

FIG. 9 is a table that illustrates operation of the pipeline for the case of several short program loops.

### DETAILED DESCRIPTION

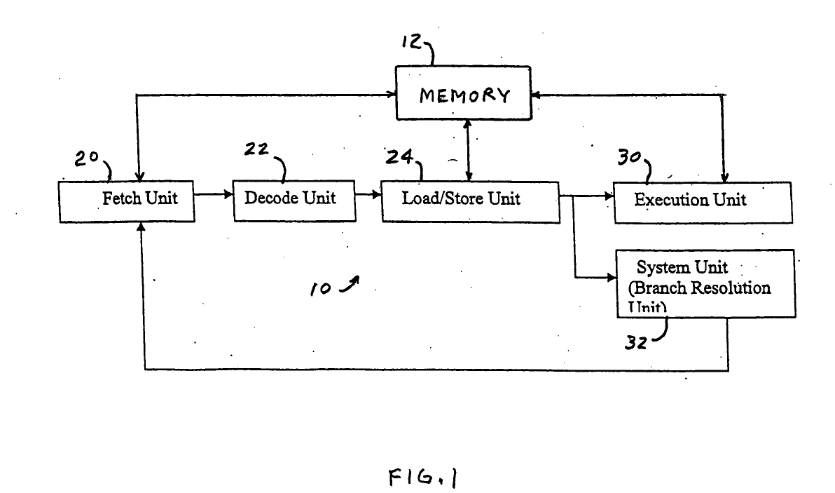

A block diagram of an embodiment of a digital signal processor (DSP) is shown in FIG. 1. The digital signal processor includes a computation core 10 and a memory 12. Computation core 10 is the central processor of the DSP. The core 10 and the memory 12 may have a pipelined architecture, as described below. In this embodiment, core 10 includes an instruction fetch unit 20, an instruction decode unit 22, a load/store unit 24, an execution unit 30 and a system unit 32, which may include a branch resolution unit.

The instruction fetch unit 20 and the instruction decode unit 22 are discussed below. Load/store unit 24 controls access to memory 12. Memory read data may be transferred from memory 12 to a register file in execution unit 30. Memory write data may be transferred from the register file in execution unit 30 to memory 12. The instruction fetch unit 20 may access memory 12 in the case of an instruction cache miss in fetch unit 20. System unit 32 provides branch resolution information to instruction fetch unit 20. Execution unit 30 may include one or more adders, multipliers, accumulators, shifters, etc., as needed for instruction execution.

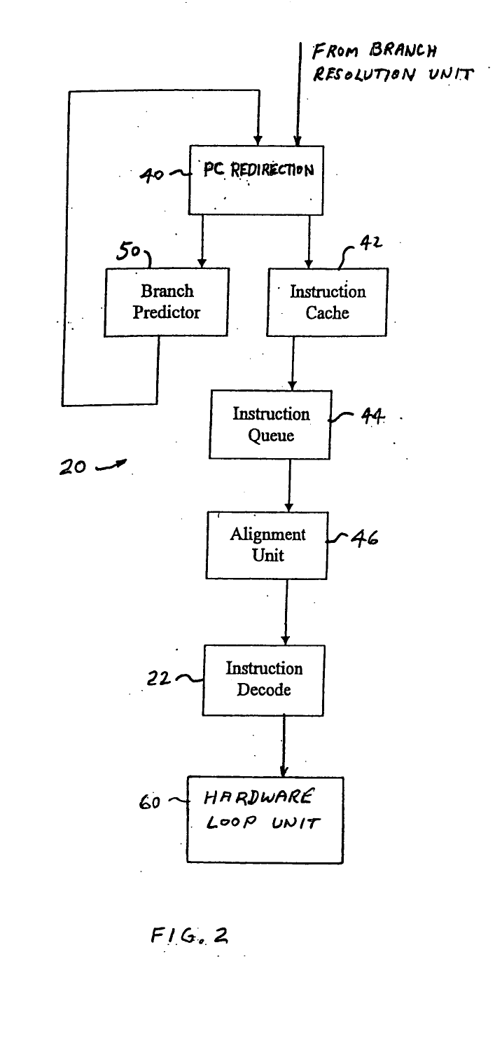

A simplified block diagram of instruction fetch unit 20 and instruction decode unit 22 is shown in FIG. 2. Instruction fetch unit 20 may include a PC (program counter) redirection unit 40, an instruction cache 42, an instruction queue 44, an instruction alignment unit 46 and a branch predictor 50. The PC redirection unit 40 determines the addresses of the instructions to be fetched. Program instructions are fetched from the instruction cache and are aligned by alignment unit 46. If necessary, instructions are placed in instruction queue 44 and then are supplied to alignment unit 46 as needed. The aligned instructions are decoded by instruction decoder 22, and the decoded instructions are passed to a hardware loop unit 60 when a program loop is present in the instruction sequence. In the event of an instruction cache miss, the requested instruction is accessed in memory 12 (FIG. 1). During normal program flow, a program counter is incremented to generate sequential instruction addresses. Branch predictor 50 predicts branch instructions and redirects instruction fetching so as to limit adverse effects of branch instructions on performance. After the branch instruction has been executed, branch resolution information is provided from system unit 32 (FIG. 1).

The computation core 10 preferably has a pipelined architecture. The pipelined architecture is a well-known architecture wherein the core includes a series of connected stages that operate synchronously, and processor operation is divided into a series of operations performed in successive pipeline stages in successive clock cycles. Thus, for example, a first stage may perform instruction fetch, a second stage may perform instruction decoding, a third stage may perform data address generation, a fourth stage may perform data memory access, and a fifth stage may perform the specified computation. An advantage of the pipelined architecture is increased operating speed. Multiple instructions may be in process simultaneously, with different instructions being in different stages of completion. It will be understood that each of the units shown in FIG. 1 may include one or more pipeline stages. In deeply pipelined processors, each basic function may be divided among several pipeline stages to increase operating speed. By way of example only, the computation core 10 may include up to thirty stages.

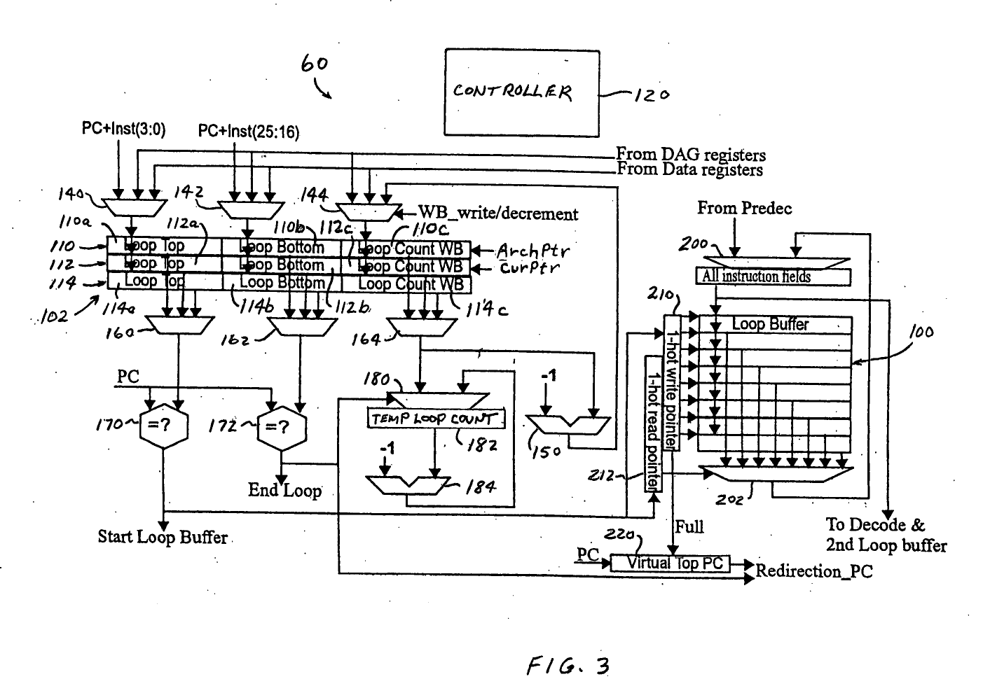

A block diagram of hardware loop unit 60 in accordance with an embodiment of the invention is shown in FIG. 3. Hardware loop unit 60 includes a loop buffer 100 for holding loop instructions, and a register file 102 for holding loop control parameters. In the embodiment of FIG. 3, register file 102 has three entries 110, 112 and 114. However, register file 102 may have more than three entries. Hardware loop unit 60 further includes a controller 120 for controlling hardware loop operation.

In a preferred embodiment, the hardware loop unit 60 includes two loop buffers to handle nested program loops. Each loop buffer is associated with a register file as shown in FIG. 3. Thus, hardware loop unit 60 may include loop buffer 0 with register file 0, loop buffer 1 with register file 1 and controller 120.

The hardware loop unit and its operation are described in detail below. The hardware loop unit 60 is configured to process consecutive, very short program loops in a deeply pipelined processor while limiting stalls. The three-entry register file 102 permits speculative processing of two consecutive program loops. A register file with more than three entries can be utilized to further enhance performance, for example in the case of a more deeply pipelined processor. Speculative copies of loop control parameters early in the pipeline permit loop instructions to be issued before the loop setup instruction is committed, thereby limiting stalls. Embodiments of the hardware loop unit 60 described herein do not require that loop control parameters be sent down the pipeline with loop instructions. As a result, chip area and power consumption are reduced.

Each entry 110, 112 and 114 in register file 102 may include a loop top register, a loop bottom register and a loop count register. Thus, entry 110 includes loop top register 110a, loop bottom register 110b and loop count register 110c. Similarly, entry 112 includes loop top register 112a, loop bottom register 112b and loop count register 112c; and entry 114 includes loop top register 114a, loop bottom register 114b and loop count register 114c. The loop top register holds the address of the first instruction of a program loop, and the loop bottom register holds the address of the last instruction of the program loop. The loop count register holds the number of program loop iterations to be executed. When the loop count value is one or zero, the loop is executed once.

As further shown in FIG. 3, an architectural pointer, ArchPtr, and a current pointer, CurPtr, are associated with register file 102. The architectural pointer points to an architectural entry in register file 102, which holds the architectural loop control parameters. The current pointer points to a current entry in register file 102, which holds the current loop control parameters. The current entry may be speculative. The architectural and current pointers may point to the same or different entries in register file 102, as discussed below.

A three-input mux 140 supplies loop top addresses to loop top registers 110a, 112a and 114a. A first input to mux 140 is the address of the loop top instruction obtained from the loop setup instruction. In particular, the loop setup instruction precedes the program loop and supplies an offset between the loop setup instruction and the first instruction of the program loop. In the embodiment of FIG. 3, the offset between the loop setup instruction and the first instruction of the program loop is specified by bits 3:0 of the loop setup instruction. Accordingly, the loop top address is obtained by adding the PC (program counter) and bits 3:0 of the loop setup instruction. The PC contains the current instruction address. A second input to mux 140 is supplied from the DAG (data address generator) registers, and a third input to mux 140 is supplied from the data registers. In some cases, the loop top address is obtained from the DAG registers or the data registers.

A three-input mux 142 supplies loop bottom addresses to loop bottom registers 110b, 112b and 114b. The loop setup instruction supplies an offset between the loop setup instruction and the last instruction of the program loop. In the embodiment of FIG. 3, the offset between the loop setup instruction and the last instruction of the program loop is specified by bits 25:16 of the loop setup instruction. Accordingly, the loop bottom address is obtained by adding the PC and bits 25:16 of the loop setup instruction. The loop bottom address is supplied to a first input of mux 142. Mux 142 also receives inputs from the DAG registers and from the data registers. In some cases, the loop bottom address is obtained from the DAG registers or the data registers.

A three-input mux 144 supplies loop count values to loop count registers 110c, 112c and 114c. A first input of mux 144 receives loop count values from an adder 150. The adder 150 decrements the loop count value in the architectural entry in register file 102 each time the loop bottom instruction is committed in the pipeline. Mux 144 also receives inputs from the DAG registers and from the data registers. In some cases, the loop count value is obtained from the DAG registers or the data registers.

The outputs of loop top registers 110a, 112a and 114a are supplied to inputs of a three-input mux 160. The outputs of loop bottom registers 110b, 112b and 114b are supplied to inputs of a three-input mux 162. The outputs of loop count registers 110c, 112c and 114c are supplied to inputs of a three-input mux 164. Muxes 160, 162 and 164 select the outputs of a current entry in register file 102. The output of mux 160 is supplied to a first input of a loop top comparator 170, and the output of mux 162 is supplied to a first input of a loop bottom comparator 172. The current program counter, PC, is input to a second input of each of loop top comparator 170 and loop bottom comparator 172. Thus, when the current instruction address matches the loop top address, a start loop signal is provided by loop top comparator 170. When the current instruction address matches the loop bottom address, an end loop signal is provided by loop bottom comparator 172. It will be understood that the start loop and end loop signals are supplied on each iteration of the program loop.

The output of mux 164 is supplied to one input of a two-input mux 180. Mux 180 is controlled by the end loop signal from comparator 172. The output of mux 180 is supplied to a temporary loop count (TLC) register 182. The output of temporary loop count register 182 is supplied to one input of an adder 184, and a value of −1 is supplied to the other input of adder 184. Adder 184 decrements the value in temporary loop count register 182 by 1 on each loop bottom match. The output of adder 184 is supplied to a second input of mux 180. The output of mux 164 is also supplied to one input of adder 150, and a value of −1 is supplied to the other input of adder 150. Adder 150 decrements by 1 the loop count value at the output of mux 164 and supplies the decremented loop count value to one input of mux 144. The loop count in the architectural entry in register file 102 is decremented each time the loop bottom instruction is committed.

In the embodiment of FIG. 3, loop buffer 100 includes 9 entries and thus may store up to 9 instructions of a program loop. The instructions may be supplied from instruction decode unit 22 (FIG. 2) to a first input of a two-input mux 200. The decoded instruction may be stored in loop buffer 100. One of the entries in the loop buffer is selected by an eight-input mux 202, and the output of mux 202 is supplied to a second input of mux 200. A 1-hot write pointer 210 controls writing into loop buffer 100 and a 1-hot read pointer 212 controls mux 202. The loop top comparator 170 controls write pointer 210 and read pointer 212. In particular, instructions are written into loop buffer 100 on the first iteration of a program loop, and the loop instructions are read from loop buffer 100 on each subsequent iteration of the loop. If the size of the loop exceeds the capacity of loop buffer 100, the address of the next loop instruction is placed in a virtual top (VTOP) register 220. Instructions for the portion of the program loop that do not fit in the loop buffer 100 are fetched from the instruction cache rather than from loop buffer 100.

When the instruction at the loop bottom is dispatched to the pipeline, based on the value of the loop count register, an implicit branch to the top of the loop is issued. In order to reduce the branch penalty from loop bottom to loop top to zero, the loop buffer 100 is used. The loop buffer 100 caches aligned instructions at the top of the loop. On the first iteration of the loop, when the PC matches the loop top register, N instructions are written into the loop buffer 100, where N is the depth of the loop buffer. The address of the first instruction that is not written into the loop buffer 100 is saved in VTOP register 220.

When the current instruction address PC matches the loop bottom value and the loop count is not zero or one, the next N instructions are issued from the loop buffer 100, while a fetch to the address in VTOP register 220 is sent to the instruction cache 42 (FIG. 2). The loop count register is also decremented by one. The branch penalty is thus hidden by the loop buffer 100. Thus, the minimum depth of the loop buffer 100 should be the penalty that is to be hidden. The instruction fetch unit is disabled when instructions are being issued from loop buffer 100.

The exit condition from the loop is reached when the current instruction address PC matches the loop bottom value and the loop count value is either zero or one. In this case, the branch to the VTOP register 220 is not issued and the instructions are issued from the instruction cache as if they were sequential instructions. Therefore, no exit penalty is associated with the hardware loop unit.

In the above example, the program loop exceeded the capacity of loop buffer 100. If the program loop completely fits within loop buffer 100, then on a loop bottom match there is no need to issue a fetch to the instruction cache. The instruction cache is stalled when a loop bottom match occurs before the loop buffer is filled. When the exit condition from the loop is detected, the stall is released and the instruction cache continues sending instructions as if they were sequential. Again, there is no exit penalty for the loop. An advantage of this scheme is that since the instruction cache is stalled, it does not operate for the entire duration of the loop execution, thereby reducing power consumption.

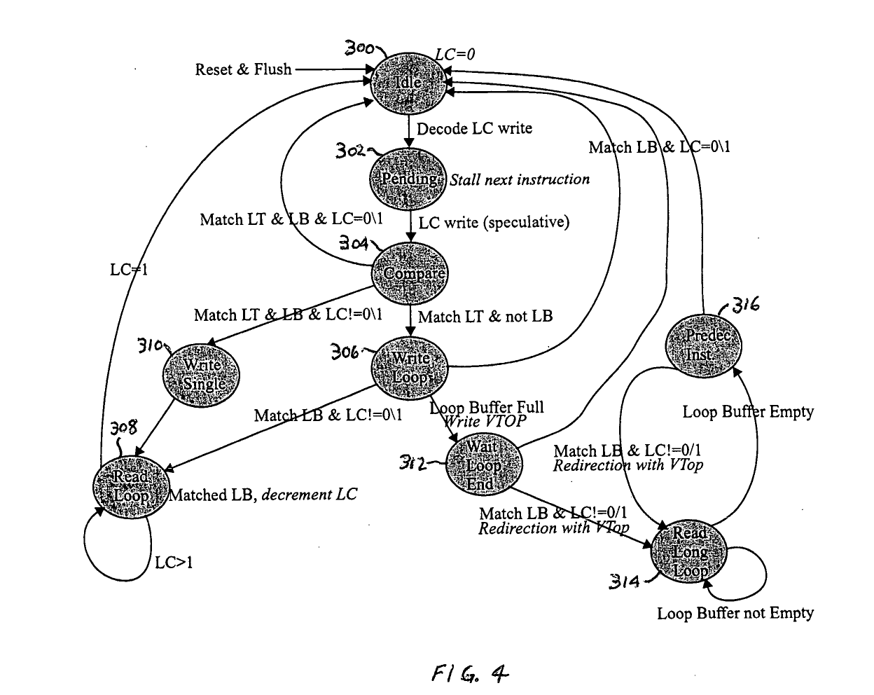

A schematic diagram that illustrates operation of a state machine implemented by controller 120 is shown in FIG. 4. State 300 is an idle state. When a loop count write of a loop setup instruction is decoded, the controller enters a pending state 302. The loop count is written to one of the loop count registers 110c, 112c and 114c (FIG. 3). The loop count write is speculative. In state 304, the current instruction address (PC) is compared with the loop top and loop bottom values in the current loop control register set. When the PC matches the loop top and does not match the loop bottom, instructions are written to the loop buffer 100 in state 306.

When the PC matches the loop bottom and the loop count is not equal to zero or one in state 306, instructions are read from loop buffer 100 in state 308. Each time the PC matches the loop bottom, the loop count in TLC register 182 is decremented. The loop instructions are read as long as the loop count is greater than zero. When the loop count equals zero, the controller returns to idle state 300.

Referring again to compare state 304, when the PC matches both the loop top and the loop bottom, a single-instruction loop is indicated. If the loop count is not equal to zero or one, a single instruction is written into the loop buffer 100 in state 310, and the controller proceeds to state 308.

Referring again to write loop state 306, when the loop buffer is full and the loop bottom has not been reached, the address of the next instruction is written in VTOP register 220 and the controller waits for loop end in state 312. The remaining instructions of the loop are fetched from the instruction cache. In write loop state 306, when the PC matches the loop bottom and the loop count is equal to zero or one, the controller returns to idle state 300.

In wait state 312, when the PC matches the loop bottom and the loop count is not equal to zero or one, the controller reads the long loop in state 314. In wait state 312, when the PC matches the loop bottom and the loop count is equal to zero or one, the controller returns to idle state 300.

In read long loop state 314, instructions are read from loop buffer 100 until the end of the loop buffer is reached. When the end of the loop buffer is reached, the controller proceeds to state 316, and instructions are fetched from the instruction cache. When the PC matches the loop bottom and the loop count is not equal to zero or one, the controller returns to state 314 for reading the long loop. In state 316, when the PC matches the loop bottom and the loop count is equal to zero or one, the controller returns to idle state 300.

As noted above, hardware loop unit 60 includes a register file associated with each loop buffer. Each register file has three entries in this embodiment. As shown in FIG. 3, an architectural pointer points to an architectural entry, and a current pointer points to a current entry, which may be speculative. The speculative entry permits the loop top and loop bottom addresses to be checked for a match with the PC early in the pipeline, typically in the instruction decode stage. The loop is executed, and when the loop setup instruction reaches the write back stage and is committed, the speculative entry in the register file is marked as the architectural entry. This arrangement permits small program loops to be executed efficiently in long pipelines.

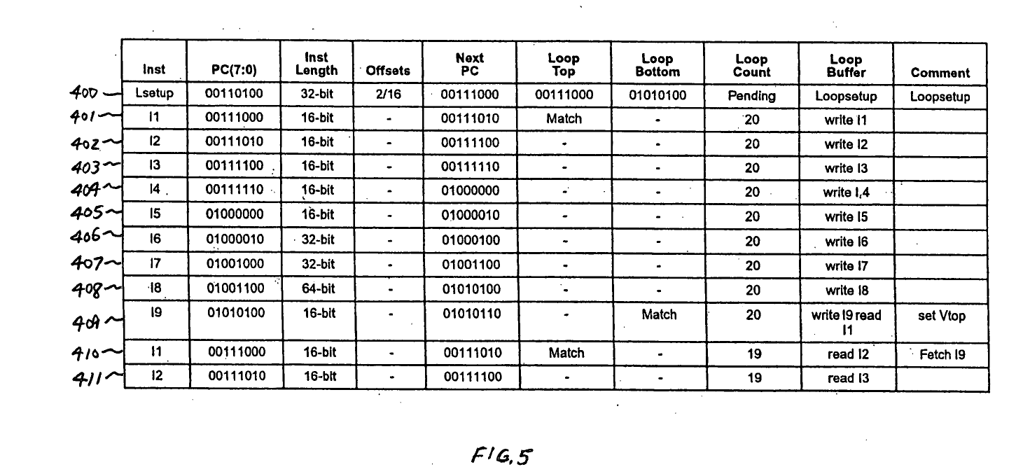

FIG. 5 is a table that illustrates a sequence of operations for a relatively long program loop. In FIG. 5, time advances from top to bottom, and each row of the table represents a clock cycle. A column labeled “Inst” indicates the instruction being processed, a column labeled “PC (7:0)” indicates bits 7:0 of the current instruction address, a column labeled “Inst Length” indicates instruction length, a column labeled “Offsets” indicates offset values contained in a loop setup instruction, and a column labeled “Next PC” indicates bits 7:0 of the next instruction address. The remaining columns of the table indicate loop top, loop bottom, loop count, loop buffer actions and comments.

In clock cycle 400, a loop setup instruction is decoded. The loop setup instruction, Lsetup, specifies offsets of two words and sixteen words to the loop top and loop bottom, respectively. The offsets are added to the PC of the loop setup instruction, and the resulting loop top and loop bottom addresses are written in the loop top and loop bottom registers of a current entry in register file 102, such as entry 112 (FIG. 3). The loop top address indicates that the next instruction I1 is the first instruction of the program loop. In clock cycle 401, the PC of instruction I1 matches the loop top address in loop top register 112a, and the loop count of 20 is written into loop count register 112c. Instruction I1 is written into loop buffer 100 and is issued for execution. In clock cycles 402-408, instructions I2-I8 of the program loop are decoded, are written into loop buffer 100 and are issued for execution on successive clock cycles. As indicated, different instructions may have the same or different lengths. In clock cycle 409, the PC of instruction I9 matches the loop bottom address in loop bottom register 112b. In response, the loop count value in TLC register 182 is decremented, instruction 19 is written into loop buffer 100 and instruction I1 is read from loop buffer 100. The process thus branches to the loop top with no penalty. In clock cycles 401-409, the respective instructions are issued for execution of the first iteration of the program loop. In clock cycle 410, the second iteration of the program loop begins and the PC for instruction I1 matches the loop top address in loop top register 112a. During this and succeeding iterations of the program loop, the instructions are read from loop buffer 100.

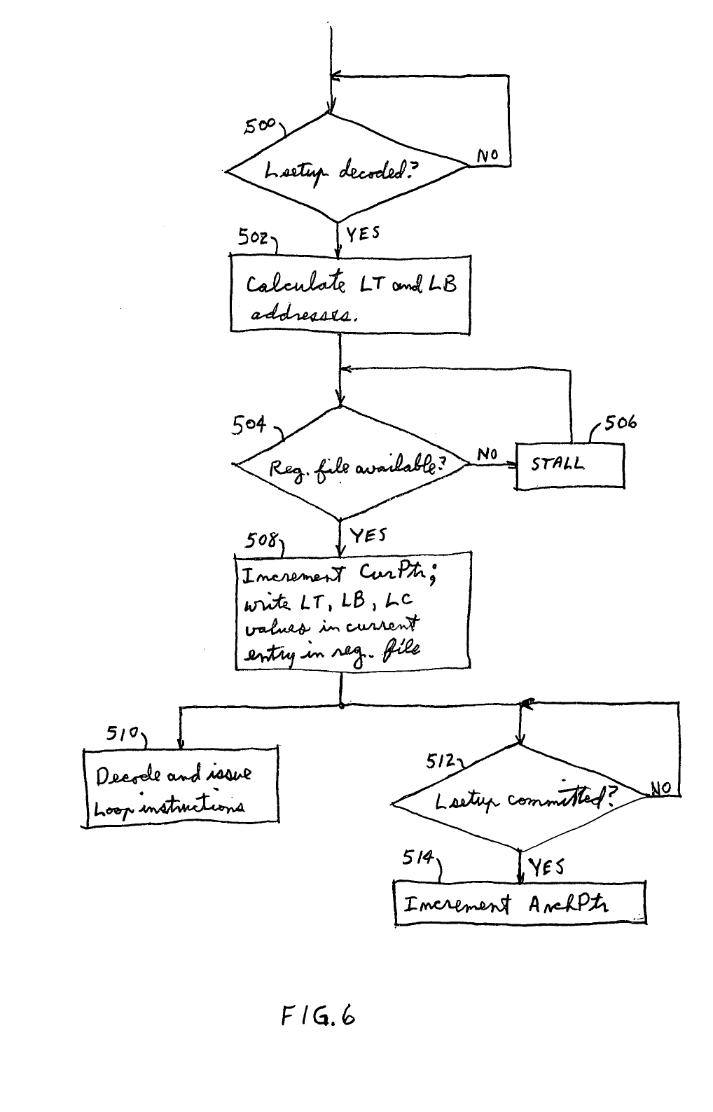

A flow diagram of a process for handling a loop setup instruction, Lsetup, is shown in FIG. 6. The process may be executed by controller 120 (FIG. 3) or by a combination of controller 120 and other circuitry in the processor. In step 500, a determination is made as to whether a loop setup instruction has been decoded. When a loop setup instruction is decoded, loop top and loop bottom addresses are calculated in step 502. As described above, the loop top address is obtained in this embodiment by adding the PC and bits 3:0 of the loop setup instruction. Similarly, the loop bottom address is obtained by adding the PC and bits 25:16 of the loop setup instruction. In step 504, a determination is made as to whether an entry is available in register file 102. If an entry is available, the current pointer is incremented in step 508 to point to the available entry, and the loop top, loop bottom and loop count values are written in the current entry in the register file. If a determination is made in step 504 that an entry is not available in the register file, processing of the loop setup instruction is stalled in step 506 until a register file entry is available.

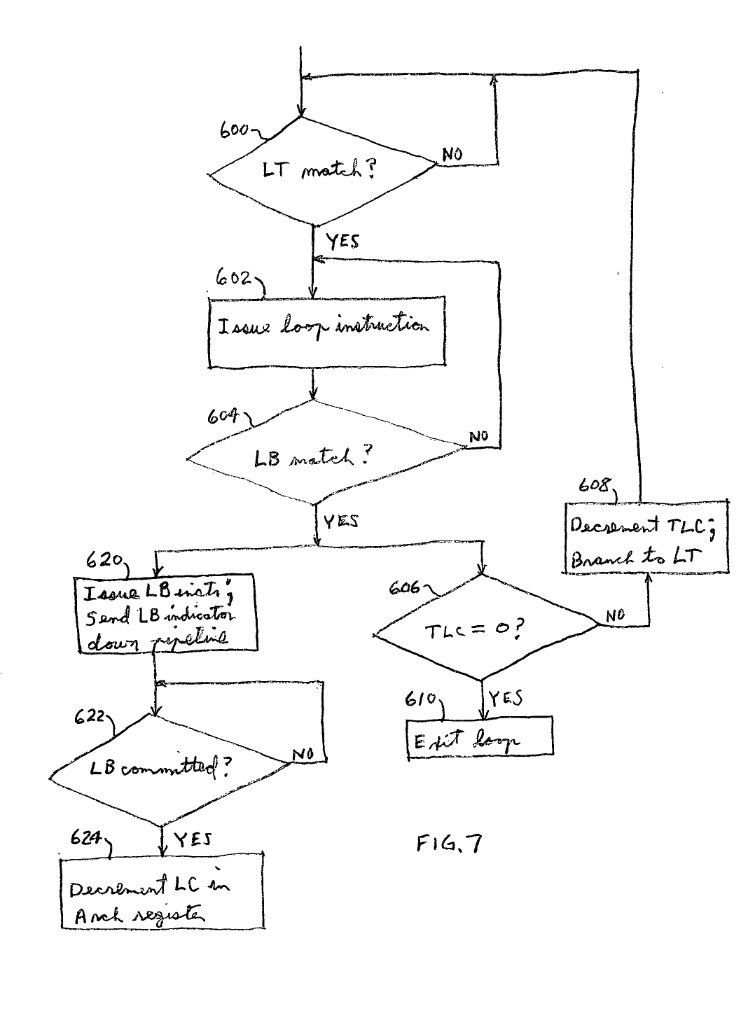

After the loop control parameters contained in the loop setup instruction have been written in the current entry in the register file, instructions of the program loop are decoded and issued in step 510. Processing of loop instructions is described in detail below in connection with FIG. 7. It will be understood that loop instructions can be issued speculatively immediately after the loop control parameters are written in the current entry in the register file.

The loop setup instruction advances down the pipeline. In step 512, a determination is made as to whether the loop setup instruction has been committed, i.e., completed execution in the pipeline. When the loop setup instruction is committed, the architectural pointer is incremented in step 514. The architectural pointer now points to the entry in register file 102 which contains the loop control parameters for the loop setup instruction. Thus, the loop control parameters for the loop setup instruction are converted from speculative loop control parameters to architectural loop control parameters.

A flow diagram of a process for issuing loop instructions is illustrated in FIG. 7. The process may be executed by controller 120 (FIG. 3) or by a combination of controller 120 and other circuitry in the processor. In step 600, comparator 170 (FIG. 3) checks for a match between the current PC and the loop top address in the current entry in register file 102. When a loop top match is found, the loop top instruction is issued in step 602. In step 604, comparator 172 (FIG. 3) compares the current PC with the loop bottom address in the current entry in register file 102 to determine a loop bottom match. If a loop bottom match is not found, the process returns to step 602 and the next loop instruction is issued. If a loop bottom match is found in step 604, a determination is made in step 606 as to whether the temporary loop count in TLC register 182 (FIG. 3) is zero. If the temporary loop count is not equal to zero, additional loop iterations are required. The temporary loop count in TLC register 182 is decremented in step 608, and the process branches to the loop top address and returns to step 600. If the temporary loop count is determined in step 606 to be zero, all required loop iterations have been completed and the process exits the loop in step 610.

When a loop bottom match is found in step 604, the loop bottom instruction is issued in step 620 and a loop bottom indicator is sent down the pipeline with the loop bottom instruction. The loop bottom indicator is used by succeeding pipeline stages to identify the loop bottom instruction. In step 622, a determination is made as to whether the loop bottom instruction has been committed. When the loop bottom instruction is committed, the loop count in the architectural entry in register file 102 is decremented in step 624.

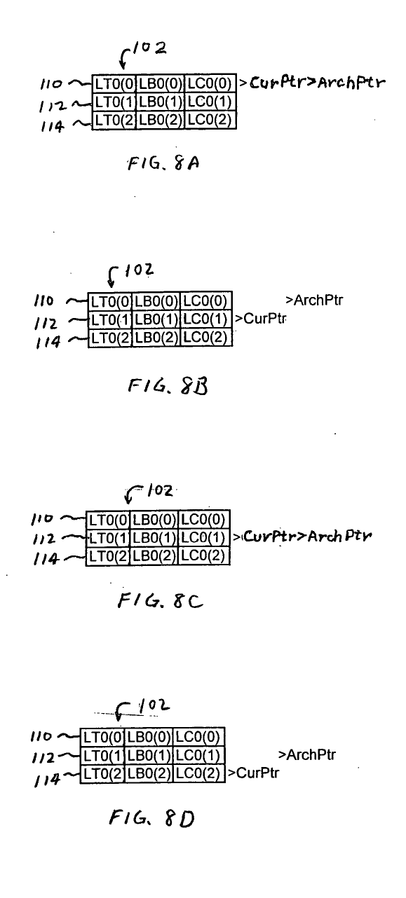

FIGS. 8A-8D illustrate register file 102, the current pointer and architectural pointer for various processor states. As discussed above, register file 102 includes entries 110, 112 and 114, each having registers for holding a loop top address, LT0, a loop bottom address, LB0, and a loop count, LC0.

FIG. 8A shows the states of the pointers after reset. The current pointer and the architectural pointer point to the same entry, entry 110, in register file 102. The entry pointed to by the architectural pointer is the architectural state.

When a loop setup instruction enters the pipeline, the current pointer is incremented to entry 112, as shown in FIG. 8B. The speculative loop control parameters from the loop setup instruction are copied into entry 112 in register file 102. Entry 112 is a speculative entry in FIG. 8B. The loop count is updated in TLC register 182. The loop top and loop bottom addresses in entry 112 are compared with the current PC for a loop top or a loop bottom match. The loop is processed as shown in FIG. 7 and described above. The temporary loop count in TLC register 182 is decremented on every loop bottom match. The architectural loop count is decremented each time the loop bottom instruction is committed.

When the loop setup instruction is committed, the architectural pointer is incremented, thereby causing it to point to entry 112, as shown in FIG. 8C. If another loop setup instruction is decoded, the current pointer is incremented and points to entry 114 in register file 102, as shown in FIG. 8D.

A third speculative loop setup instruction will produce a stall if an entry is not available in register file 102. If an interrupt or pipeline abort occurs, the current pointer is moved to point to the same entry as the architectural pointer. Following the interrupt or pipeline abort, execution continues from the state defined by the architectural entry in the register file.

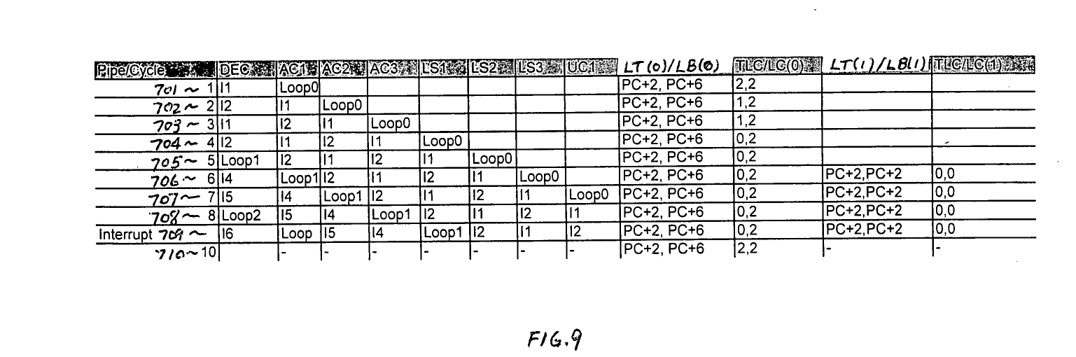

FIG. 9 is a table that illustrates instructions advancing through the pipeline for the case of several short program loops in succession. In FIG. 9, time advances from top to bottom, and each row of the table represents a clock cycle. A column labeled “DEC” represents an instruction decoder pipeline stage, columns labeled “AC1” to “AC3” represent data address generation (DAG) pipeline stages, columns labeled “LS1” to “LS3” represent load/store pipeline stages and a column labeled “UC1” represents a first execution stage of the pipeline. A column labeled “LT(0)/LB(0)” represents loop top and loop bottom addresses in entry 110 of register file 102. A column labeled “TLC/LC(0)” represents the temporary loop count in TLC register 182 and the loop count in entry 110 of register file 102, respectively. A column labeled “LT(1)/LB(1)” represents loop top and loop bottom addresses in entry 112 of register file 102. A column labeled “TLC/LC(1)” represents the temporary loop count in TLC register 182 and the loop count in entry 112 in register file 102, respectively.

As shown, a first loop setup instruction, Loop0, enters stage AC1 in cycle 701. The current pointer has been incremented to point to entry 110 in register file 102. The loop top address, PC+2, the loop bottom address, PC+6, and the loop count value, 2, are written in entry 110. A loop including instructions I1 and I2 has two iterations, with the loop instructions being issued on clock cycles 702-705. In cycle 702, the loop bottom match is detected in the decode stage. The temporary loop count is decremented from 2 to 1 on the loop bottom match. The temporary loop count reflects the number of loop bottom matches that have occurred. It may be noted that on the loop bottom match in the decoder stage, the temporary loop count in TLC register 182 is decremented, but the loop count in the register file is not decremented at this time.

On cycle 705, a second loop setup instruction, Loop1, enter the decode stage, and the current pointer is incremented to entry 112 in register file 102. The instructions of the first loop have been issued and sent down the pipeline. The TLC value in cycle 705 is zero. The loop control parameters of the second loop setup instruction are written in entry 112 of register file 102 in cycle 106. The second loop has a loop count of zero. The loop unit is configured such that any loop with a loop count set to zero or one executes once. The TLC value starts at zero and remains at zero. The second loop includes instructions I4 and I5.

In clock cycle 708, a third loop setup instruction, Loop2, enters the decode stage. At this point, the first loop has committed. Thus, the third loop setup instruction does not stall. On cycle 709, an interrupt occurs. Only the first loop setup instruction, loop zero, has committed and none of the loop bottom batches or the loop setup instructions for the other loops have committed. The current pointer is moved to point to the architectural entry. The architectural pointer points to the registers in the register file corresponding to the loop control parameters for the first loop setup instruction, Loop0. On cycle 710, the TLC is reset to the value of two and the first loop setup instruction, Loop0, restarts execution.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. A method for issuing instructions in a processor having a pipeline, comprising:
(a) providing a loop buffer for holding program loop instructions and a register file for holding speculative and architectural loop control parameters;
(b) in response to decoding of a first loop setup instruction, marking a first entry in the register file as a current entry and writing in the first entry loop control parameters represented in the first loop setup instruction;
(c) marking the current entry in the register file as an architectural entry in response to the first loop setup instruction being committed in the pipeline;
(d) sending a loop bottom indicator down the pipeline with a loop bottom instruction.

2. A method as defined in claim 1, further comprising decrementing a loop count in the architectural entry in the register file in response to the loop bottom instruction being committed in the pipeline.

3. A method as defined in claim 1, further comprising issuing instructions of the program loop according to the loop control parameters in the current entry in the register file.

4. A method as defined in claim 1, wherein the register file has at least three entries.

5. A method as defined in claim 4, further comprising generating a current pointer to the current entry in the register file and generating an architectural pointer to the architectural entry in the register file.

6. A method as defined in claim 5, further comprising incrementing the current pointer to a second entry in the register file in response to decoding of a second loop setup instruction and writing in the second entry loop control parameters represented in the second loop setup instruction.

7. A method as defined in claim 6, further comprising incrementing the architectural pointer to the second entry in the register file in response to the second loop setup instruction being committed.

8. A method as defined in claim 6, further comprising moving the current pointer to a location of the architectural pointer in response to an interrupt or a pipeline abort.

9. A method as defined in claim 1, wherein step (b) comprises writing a loop top address to a loop top register, writing a loop bottom address to a loop bottom register and writing a loop count to a loop count register.

10. A method as defined in claim 9, further comprising comparing a current instruction address with the loop top address to determine a loop top match and comparing the current instruction address with the loop bottom address to determine a loop bottom match.

11. A method as defined in claim 10, further comprising writing a temporary loop count in a temporary loop count register and decrementing the temporary loop count on each loop bottom match.

12. A method as defined in claim 11, further comprising exiting the program loop when the temporary loop count has decremented to zero.

13. A method as defined in claim 1, further comprising stalling a loop setup instruction when the register file does not have an available entry.

14. A method as defined in claim 1, wherein instructions are issued without sending the loop control parameters down the pipeline.

15. A method as defined in claim 1, further comprising writing instructions of the program loop to the loop buffer on a first iteration of the program loop.

16. A method for controlling a program loop in a processor having a pipeline, comprising:
(a) providing a loop buffer for holding program loop instructions and a register file having at least three entries for holding speculative and architectural loop control parameters;
(b) marking a first entry in the register file as a current entry in response to decoding of a first loop setup instruction and writing in the first entry loop control parameters represented in the first loop setup instruction; and
(c) marking the first entry in the register file as an architectural entry in response to the first loop setup instruction being committed in the pipeline.

17. Apparatus for issuing instructions in a processor having a pipeline, comprising:
a loop buffer for holding program loop instructions;
a register file having at least three entries for holding speculative and architectural loop control parameters; and
a controller including means for marking a first entry in the register file as a current entry in response decoding of a first loop setup instruction and for writing in the first entry loop control parameters represented in the first loop setup instruction, and means for marking the current entry in the register file as an architectural entry in response to the first loop setup instruction being committed.

18. Apparatus as defined in claim 17, wherein the controller further comprises means for issuing instructions of the program loop according to the loop control parameters in the current entry in the register file, sending a loop bottom indicator down the pipeline with a loop bottom instruction, and decrementing a loop count in the architectural entry in the register file in response to the loop bottom instruction being committed in the pipeline.

19. Apparatus as defined in claim 18, wherein the controller further comprises means for marking a second entry in the register file as the current entry in response to decoding of a second loop setup instruction and for writing in the second entry loop control parameters represented in the second loop setup instruction, and means for marking the second entry in the register file as the architectural entry in response to the second loop setup instruction being committed.

20. Apparatus as defined in claim 17, wherein each entry in the register file comprises a loop top register for holding a loop top address, a loop bottom register for holding a loop bottom address and a loop count register for holding a loop count.

21. Apparatus as defined in claim 20, further comprising a loop top comparator for comparing a current instruction address with the loop top address to determine a loop top match and a loop bottom comparator for comparing the current instruction address with the loop bottom address to determine a loop bottom match.

22. Apparatus as defined in claim 21, further comprising a temporary loop count register for holding a temporary loop count, wherein the controller further comprises means for decrementing the temporary loop count on each loop bottom match.

23. Apparatus as defined in claim 22, wherein the controller further comprises means for exiting the program loop when the temporary loop count has decremented to zero.

24. Apparatus as defined in claim 23, wherein the controller further comprises means for stalling when a loop setup instruction is decoded and the register set does not have an available entry.

25. Apparatus as defined in claim 17, wherein the controller is configured for operation without sending the loop control parameters down the pipeline.

26. Apparatus as defined in claim 17, wherein the controller includes means for writing instructions of the program loop to the loop buffer on a first loop iteration.

27. Apparatus as defined in claim 18, wherein the controller includes means for generating a current pointer for marking the current entry in the register file and for generating an architectural pointer for marking the architectural entry in the register file.

28. Apparatus as defined in claim 27, wherein the controller includes means for incrementing the current pointer in response to decoding of a loop setup instruction.

29. Apparatus as defined in claim 28, wherein the controller includes means for incrementing the architectural pointer in response to a loop setup instruction being committed in the pipeline.

30. Apparatus as defined in claim 27, wherein the controller includes means for moving the current pointer to a location of the architectural pointer in response to an interrupt or a pipeline abort.
